(19) United States
(12) Patent Application Publication
(10) Pub. No.: US 2015/0062334 A1
(43) Pub. Date: Mar. 5, 2015

(54) Systems and Methods for Image Capture and Distribution in Venues

(71) Applicant: FanPix, LLC, San Diego, CA (US)

(72) Inventors: William Dickinson, San Diego, CA (US); Misha Manulis, San Diego, CA (US)

(73) Assignee: FanPix, LLC

(21) Appl. No.: 14/308,558

(22) Filed: Jun. 18, 2014

Related U.S. Application Data
(60) Provisional application No. 61/871,838, filed on Aug. 29, 2013.
(60) Provisional application No. 61/904,393, filed on Nov. 14, 2013.

(51) Int. Cl. H04N 7/18

(52) U.S. Cl. CPC H04N 7/181
USPC 348/143

(57) ABSTRACT

Systems and methods for capturing and distributing images in venues in accordance with embodiments of the invention are illustrated. In one embodiment, a venue image capture system includes a set of camera systems installed in a venue and a set of fan experience devices, wherein a camera system includes a camera and a camera controller, wherein a camera system in the set of camera systems is configured to obtain a piece of trigger data, capture a set of images in response to the trigger data, and transmit the set of images, and wherein a fan experience device is configured to determine fan experience device location data, obtain processed image data, wherein the processed image data includes image data and metadata identifying the location captured in the processed image data, and display the obtained processed image data.

### CROSS-REFERENCE TO RELATED APPLICATIONS

The current application claims priority to U.S. Provisional Patent Application Ser. No. 61/871,838, filed Aug. 29, 2013, and U.S. Provisional Patent Application Ser. No. 61/904,393, filed Nov. 14, 2013, the disclosures of which are hereby incorporated by reference in their entirety.

### FIELD OF THE INVENTION

The present invention is generally related to the capture and distribution of images and more specifically to the capture, processing, and delivering of images to various users.

### BACKGROUND

Group events typically bring large crowds of people to one or more event venues for spectating live activities or performances, generally to the enjoyment of the spectator. During various group events, particularly large group events including sports or concerts, the reactions of individuals watching the live performances are highly animated. A photograph of these situations provides a unique and yet highly beneficial and desired memento or keepsake for a spectator.

An online social network is an online service, platform, or site that focuses on social networks and relations between individuals, groups, organizations, etc. . . . that forms a social structure determined by their interactions. These can include shared interests, activities, backgrounds, or real-life connections. A social network service can include a representation of each user (e.g., as a user profile), social links, and a variety of additional services. For example, user profiles can include photos, lists of interests, contact information, and other personal information. Online social network services are web-based and provide means for users to interact over the Internet, e.g., such as private or public messaging, e-mail, and instant messaging. Social networking sites allow users to share photos, ideas, activities, events, and interests within their individual networks.

### SUMMARY OF THE INVENTION

Systems and methods for capturing and distributing images in venues in accordance with embodiments of the invention are illustrated. In one embodiment, a venue image capture system includes a set of camera systems installed in a venue and a set of fan experience devices, wherein a camera system in the set of camera systems includes a camera including an imager configured to capture image data and a camera controller configured to obtain trigger data and configure the camera to capture an image, wherein a camera system in the set of camera systems is configured to obtain a piece of trigger data, capture a set of images in response to the trigger data, where the set of images captures a sub-section of the venue, and transmit the set of images, and wherein a fan experience device includes a processor and a memory connected to the processor and configured to store a fan experience application, and wherein the fan experience application configures the processor to determine fan experience device location data, obtain processed image data, wherein the processed image data includes image data and metadata identifying the location captured in the processed image data, and the location captured in the obtained processed image data corresponds to the determined fan experience device location data, and display the obtained processed image data.

In an additional embodiment of the invention, a camera system in the set of camera systems further includes a mounting plate configured to attach the camera system to the venue, a pan pulley configured to adjust the pan of the camera, and a tilt pulley configured to adjust the tilt of the camera, wherein the camera controller is configured to adjust the position of the camera using the pan pulley and the tilt pulley.

In another embodiment of the invention, a camera system in the set of camera system further includes calibration data that configures the camera controller to move the camera between a set of pre-defined positions during the capture of a set of images.

In yet another additional embodiment of the invention, the camera controller is configured to obtain a second piece of trigger data indicating that the camera system should stop capturing images.

In still another additional embodiment of the invention, the camera controller is configured to store the last position of the camera in response to obtaining the second piece of trigger data, stop capturing images in response to obtaining the second piece of trigger data, and when the camera controller receives a third piece of trigger data, start capturing images beginning from the stored last position in the set of pre-defined positions.

In yet still another additional embodiment of the invention, the camera controller is configured to start capturing a set of images beginning from a roaming position in the set of pre-defined positions.

In yet another embodiment of the invention, the camera system further includes movement sensors configured to measure the movement of the camera, wherein the camera controller is configured to capture an image in the set of images when the movement of the camera is below a threshold value.

In still another embodiment of the invention, the camera system further includes a gyroscope configured to stabilize the camera system.

In yet still another embodiment of the invention, further including a venue manager server system, wherein each camera system is configured to transmit camera system health data to the venue manager server system and the venue manager server system is configured to generate an administrative interface based on the camera system health data.

In yet another additional embodiment of the invention, the venue manager server system is further configured to identify when a camera system in the set of camera systems has failed, determine a subset of the camera systems in the set of camera systems that can provide coverage of the failed camera system, and reconfigure the subset of camera systems in the set of camera systems to cover the sub-section of the venue covered by the failed camera system.

In still another additional embodiment of the invention, the venue manager server system reconfigures a camera system by transmitting updated camera calibration data to each camera system in the subset of camera systems.

In yet still another additional embodiment of the invention, the venue manager server system is configured to dynamically generate the updated camera calibration data based on the camera system health data.

In yet another embodiment of the invention, the venue manager server system is configured to obtain event metadata describing one or more moments during the event and transmit the event metadata to a venue image server system.

In still another embodiment of the invention, the camera systems are configured to transmit the captured image data to the venue manager server system and the venue manager server system is configured to transmit the captured image data to a venue image server system.

In yet still another embodiment of the invention, a camera system in the set of camera systems is configured to transmit the captured image data to a venue image server system.

In yet another additional embodiment of the invention, the venue image capture system further including a venue image server system wherein the venue image server system includes a venue image server processor and a venue image server memory configured to store a venue image processing application and the venue image processing application configures the venue image server processor to obtain captured image data, where the captured image data corresponds to a sub-section of the venue, obtain event metadata, process the captured image data to generate processed image data, where the processed image data includes metadata describing the location of the seat associated with the processed image data, and associate a portion of the event metadata with the processed image data.

In still another additional embodiment of the invention, the venue image processing application further configures the venue image server processor to obtain advertisement targeting data, wherein the advertisement targeting data configures a fan experience device to display a piece of advertising data and associate advertisement targeting data with the processed image data.

In yet still another additional embodiment of the invention, the venue image processing application further configures the venue image server processor to associate a set of advertising data with the processed image data based on the advertising targeting data and transmit the set of advertising data with the processed image data.

In yet another embodiment of the invention, the fan experience application configures the processor to obtain advertising targeting data, request advertising data, and display the requested advertising data.

In still another embodiment of the invention, the advertising data is requested from a third-party advertising system.

In yet still another embodiment of the invention, the advertising data is requested from a venue image server system.

In yet another additional embodiment of the invention, the fan experience application configures the processor to obtain user data describing the fan associated with the fan experience device and the advertising targeting data is based on the obtained user data.

In still another additional embodiment of the invention, the fan experience application configures the processor to measure engagement with the requested advertising data and generate engagement data describing the measured engagement and the engagement data is utilized to refine the advertising targeting data.

In yet still another additional embodiment of the invention, the generated engagement data further describes engagement with the fan engagement device.

In yet another embodiment of the invention, the fan experience application configures the processor to obtain a token issued for a particular online social network that can be utilized to access a portion of the user's online social networking profile via an application programming interface provided by the online social network, receive a request to share a processed image via the online social network, and generate a post on the online social network using the token and the processed image.

In still another embodiment of the invention, the camera systems in the set of camera systems are configured to communicate in a peer-to-peer network.

Yet another embodiment of the invention includes a method for displaying image data captured during an event at a venue including determining fan experience device location data using a fan experience device, where the fan experience device location data identifies a location within the venue associated with the fan, obtaining processed image data using the fan experience device, wherein the processed image data is generated based on captured image data captured using a camera system installed in the venue and configured to capture the sub-section of the venue that includes the location described by the fan experience device location data, where the camera system includes a camera including an imager configured to capture image data and a camera controller configured to obtain trigger data and configure the camera to capture an image, and the camera system is configured to obtain a piece of trigger data, capture a set of images in response to the trigger data, where the set of images captures a sub-section of the venue, and transmit the set of images, the processed image data includes image data and metadata identifying the location captured in the processed image data, and the location captured in the obtained processed image data corresponds to the determined fan experience device location data, and displaying the obtained processed image data using the fan experience device.

### BRIEF DESCRIPTION OF THE DRAWINGS

FIG. 1 is a network diagram of a venue image capture system in accordance with an embodiment of the invention.

FIG. 2A is a conceptual illustration of a venue with a venue image capture system installed in accordance with an embodiment of the invention.

FIG. 2B is a conceptual illustration of a camera system configured to be installed in a venue as part of a venue image capture system in accordance with an embodiment of the invention.

FIG. 2C is a conceptual illustration of an alternative camera system configured to be installed in a venue as part of a venue image capture system in accordance with an embodiment of the invention.

FIG. 2D is a conceptual illustration of a venue image server system in accordance with an embodiment of the invention.

FIG. 2E is a conceptual illustration of a fan experience device in accordance with an embodiment of the invention.

FIG. 3 is a flow chart of a process for capturing and distributing images captured during a venue event in accordance with an embodiment of the invention.

FIG. 4A is a conceptual illustration of a section of a venue with a set of capture regions defined in accordance with an embodiment of the invention.

FIG. 4B is a flow chart of a process for calibrating an array of camera systems configured to capture images within a venue in accordance with an embodiment of the invention.

FIG. 5A is a flow chart of a process for capturing images of a moment during a venue event in accordance with an embodiment of the invention.

FIG. 5B is a flow chart of a process for capturing images of a moment during a venue event using a venue manager in accordance with an embodiment of the invention.

FIG. 6A is a conceptual illustration of a seat index applied to a section of a venue in accordance with an embodiment of the invention.

FIG. 6B is a flow chart of a process for identifying moments within images captured during a venue event in accordance with an embodiment of the invention.

FIG. 7A is a conceptual illustration of a user interface for viewing processed images of a moment captured at a venue event in accordance with an embodiment of the invention.

FIG. 7B is a flow chart of a process for distributing images captured during a venue event in accordance with an embodiment of the invention.

FIG. 8 is a flow chart of a process for targeting advertising within a venue image capture system in accordance with embodiments of the event.

### DETAILED DISCLOSURE OF THE INVENTION

Turning now to the drawings, venue image capture systems in accordance with embodiments of the invention are illustrated. Fans attend a wide variety of events at venues including, but not limited to, stadiums, arenas, ballparks, auditoriums, music halls, amphitheaters, outdoor areas, and any other space where fans can gather to attend an event. Certain moments during these events evoke emotional reactions from the crowd of fans in attendance. During a crowd reaction period there can be a variety of emotions expressed. The reactions can often be broken down into several phases, such as a highly animated release of tension displayed by the subjects jumping, arms raised and intense facial expressions and a period where fans turn to companions to display their emotions to them.

Venue image capture systems in accordance with embodiments of the invention are configured to capture images of the reactions of fans to moments occurring during an event. These images are distributed to the fans during and after the event. Venue image capture systems employ a number of camera systems installed throughout a venue to capture images of particular areas of the venue. The camera systems are calibrated to capture images of particular sub-sections of the venue. Many venues include venue management server systems configured to manage the camera systems installed in the venue. These captured images can then be processed in order to capture the reactions of each individual fan in attendance. As described in more detail below, metadata describing the event and/or the particular moment captured can be associated with the processed images. This metadata can be captured using the camera systems and/or the venue manager server system and transmitted to the venue image capture server system. The venue image server system processes the captured image and associates the event metadata with the processed images. In several embodiments, the event metadata is provided via an application programming interface (API) and a reference to the event metadata is included in the processed images. In this way, the event metadata can be dynamically associated with the processed images at any of a variety of times, such as when the processed images are viewed using a fan experience device and when the processed images are transmitted. In a variety of embodiments, the venue manager server system can track metrics related to the performance of the camera systems, such as the number of moments captured by the camera systems, and/or provide reporting functionality for tracking and monitoring performance-related metrics. As described in more detail below, these metrics can include, but are not limited to, the health of the camera systems, the number of sequences captured, the number of images captured, and sensor data.

Fans can access the venue image capture system using fan experience devices. The fan experience devices are configured to obtain fan information such as, but not limited to, the particular seat the fan was sitting in (or, as described below, the fan's location within a crowd) for a particular event. Images of the fan reacting to the moments occurring during the event can then be viewed and/or manipulated by the fan via the fan experience device. In a variety of embodiments, these images and/or the associated metadata can be shared via one or more online social networks, such as by using account access information or the fan's account with the online social network(s). Account access information includes a username and password combination, a token issued for a particular online social network that can be utilized to access a portion of the user's online social networking profile via an application programming interface provided by the online social network, or any other data utilized to access the online social network as appropriate to the requirements of specific applications of the invention. Additionally, advertising data and/or any other custom content can be associated with the images and transmitted to the fan experience devices. This advertising data can be highly targeted toward the fan based on the large amount of event- and fan-specific data available. In many embodiments, engagement with the advertisements and/or the fan experience device can be tracked.

It should be noted that, while the processes herein are described in a particular sequence, any of the various processes described herein can be performed in alternative sequences and/or in parallel (on different computing devices) in order to achieve similar results in a manner that is more appropriate to the requirements of a specific application. Additionally, while the systems and methods herein are primarily described with respect to image data, any other data such as video data and audio data, can be utilized in accordance with several embodiments of the invention. Systems and methods for capturing and distributing images to fans attending an event in accordance with embodiments of the invention are described below.

### Venue Image Capture Systems

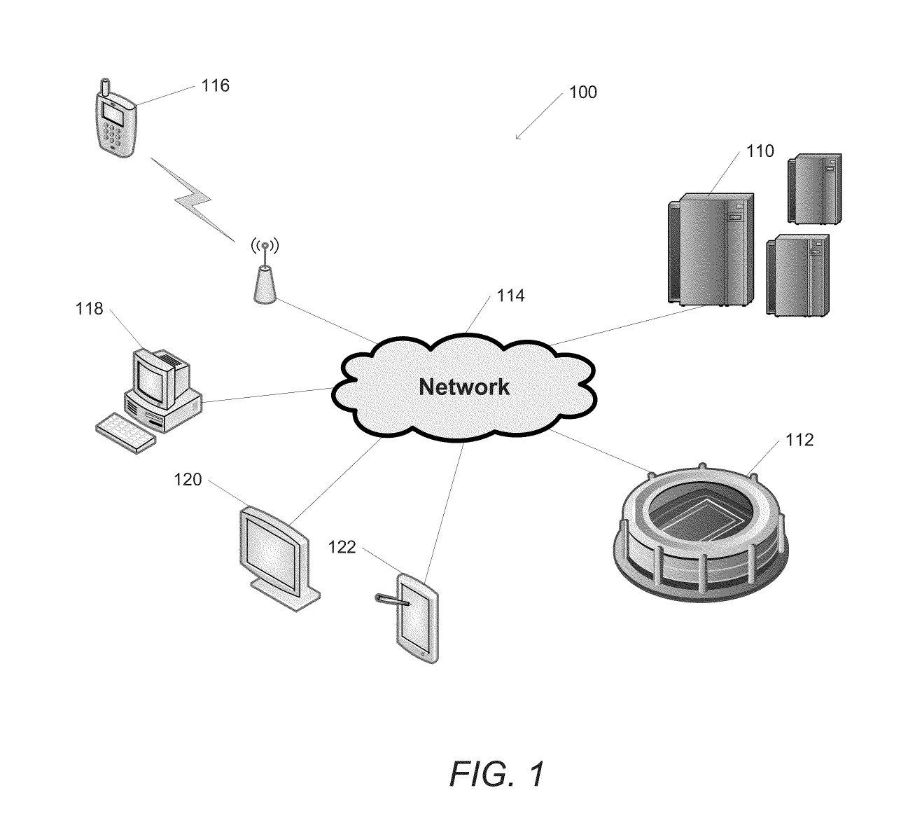

A venue image capture system in accordance with an embodiment of the invention is illustrated in FIG. 1. The venue image capture system 100 includes a venue image server system 110, a venue 112, and one or more fan engagement devices such as mobile phones 116, personal computers 118, interactive kiosks 120, and/or tablet devices 122 connected via a network 114. The network 114 can be a variety of networks, such as a local area network (LAN), a wide area network (WAN), the Internet, or any other network (or combination thereof) as appropriate to the requirements of specific applications. The network can be wired, wireless (in licensed bands and/or in unlicensed bands), or a combination of wired and wireless as appropriate to the requirements of specific applications of embodiments of the invention.

The venue 112 includes a set of camera systems calibrated to capture images of the fans attending events held at the venue 112. The construction of the camera systems and techniques for installing the camera systems within the venue 112 are described in more detail below. Images captured by the camera systems can be transmitted to the venue image server system 110 where, in many embodiments, the images can be processed. In several embodiments, the venue image server system 110 includes one or more servers executing on a cloud-based computing platform, such as the Amazon Web Services platform provided by Amazon.com, Inc. of Seattle, Wash. In many embodiments, the venue image server system 110 is configured to dynamically scale the computing power utilized by the venue image server system 110 based on the number of captured venue images to process in order to achieve a balance between the speed of delivery of processed images and the cost of processing those images. In several embodiments, the operational metrics of the venue image server system 110 are tracked. These operational metrics can be utilized to ensure that a service-level agreement is being fulfilled and/or improve the utilization of the venue image server system 110. However, it should be noted that the venue 112 can include a venue manager server system configured to process the images on-site and transmit the processed images to the venue image server system 110 and/or the fan engagement devices directly as appropriate to the requirements of specific applications of the invention. In a variety of embodiments, the venue manager server system is configured to monitor the health and status of each of the camera systems and provide alerts when a camera system experiences problems. In several embodiments, the venue image server system 110 is configured to obtain information from multiple venue manager server systems installed in a variety of venues 112, thereby providing a centralized management platform for monitoring the performance of camera systems installed in a variety of venues 112. This centralized management platform can also be utilized to control the camera systems in a particular venue if the venue manager server system for that venue experiences technical difficulties. Additionally, it should be noted that the venue manager server system can be located outside the premises of the venue. In this way, the venue manager server system can provide for the remote management of the camera systems contained within the venue.

In many embodiments, the camera systems form a peer-to-peer network. In a variety of embodiments, the camera systems are configured to automatically detect cameras joining and/or leaving the peer-to-peer network. The cameras can then dynamically reconfigure themselves to account for changes in the peer-to-peer network utilizing techniques similar to those described below. Additionally, the camera systems can be managed directly. In several embodiments, the camera systems are configured to provide an interface (e.g. a web interface generated using a web server running on a controller driving the camera system) that can be accessed using a web browser or any other applicable application. In this way, any configuration device (such as a venue manager server system) can communicate with one or more of the camera systems to view the status of the camera system and/or manage the camera systems remotely.

Fan engagement devices can be configured to obtain the processed images from the venue image server system 110. As described in more detail below, fan engagement devices can receive processed images at random times, at specific moments during the game, and/or on demand. In a variety of embodiments, fan engagement devices provide information regarding a particular event, including (but not limited to) the date of the event and seat data (i.e. the section, row, and seat number the fan was sitting in) and the venue image server system 110 provides images processed for that particular seat. Fans can then view the images, share the images via online social networks, and/or request prints of particular images. In many embodiments, metadata describing the moment captured and/or the event as a whole can be associated with the images and displayed in addition to the images. Additionally, advertising content can be displayed along with the images and/or metadata. As described in more detail below, the advertising data can be targeted specifically to fans based on factors including (but not limited to) user data describing the fan, the particular moment being captured, the type of event being attended, the time in the event the image is viewed, and/or any of a variety of factors as appropriate to the requirements of specific applications in accordance with embodiments of the invention. In many embodiments, a fan experience device (such as a kiosk) allows fans to view their images and/or obtain a physical copy of the captured image. In several embodiments, the fan experience device is configured to obtain a fee before printing (or mailing) the physical copy.

Although a specific architecture for a venue image capture system in accordance with an embodiment of the invention is conceptually illustrated in FIG. 1, any of a variety of architectures capable of capturing event images, processing those images, and transmitting the images to fan engagement devices, including those that are self-contained within the venue 112 rather than distributing data via the Internet, can also be utilized in accordance with embodiments of the invention. Systems and methods for venue image capture in accordance with embodiments of the invention are discussed in detail below.

### Venues Having Venue Image Capture Systems

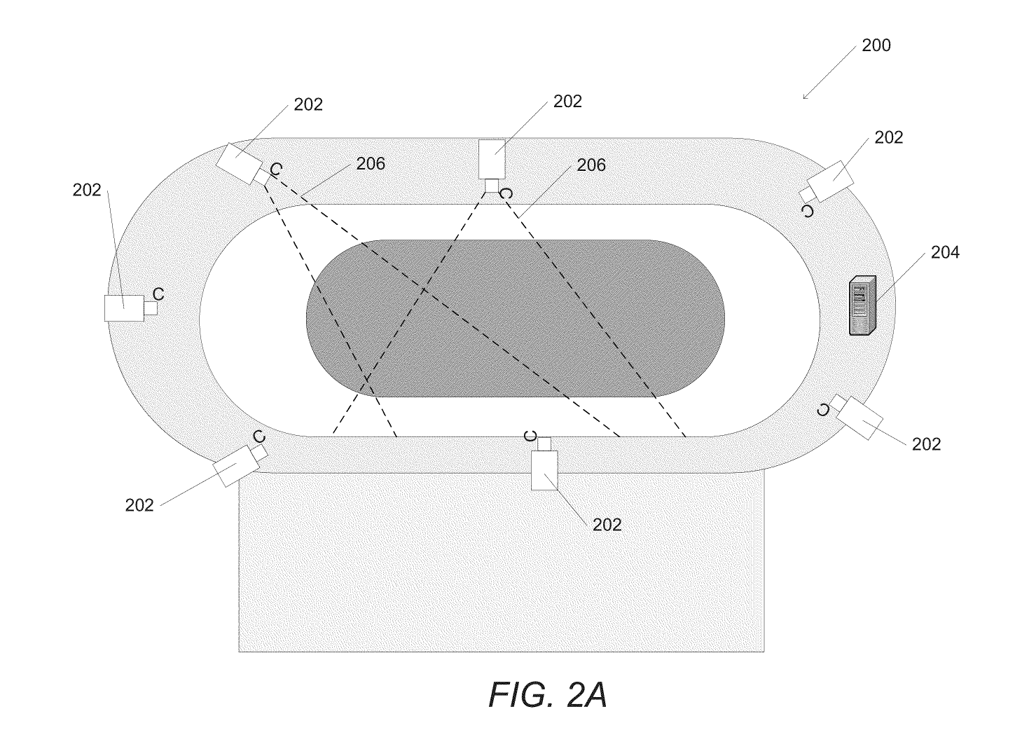

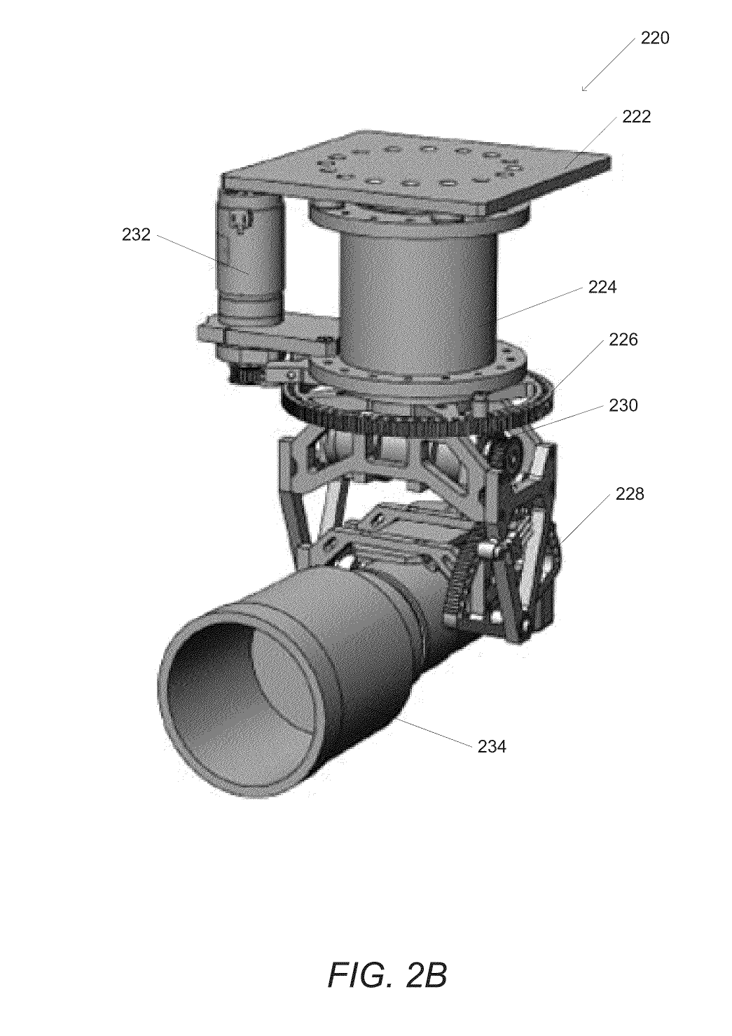

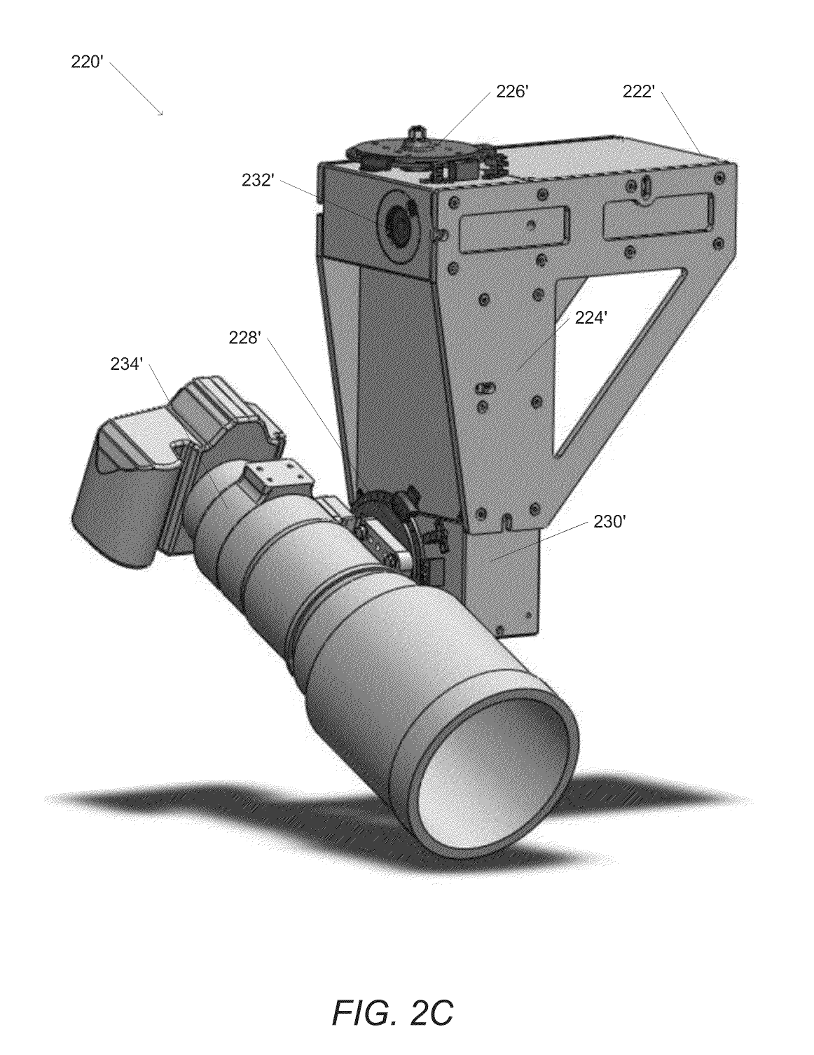

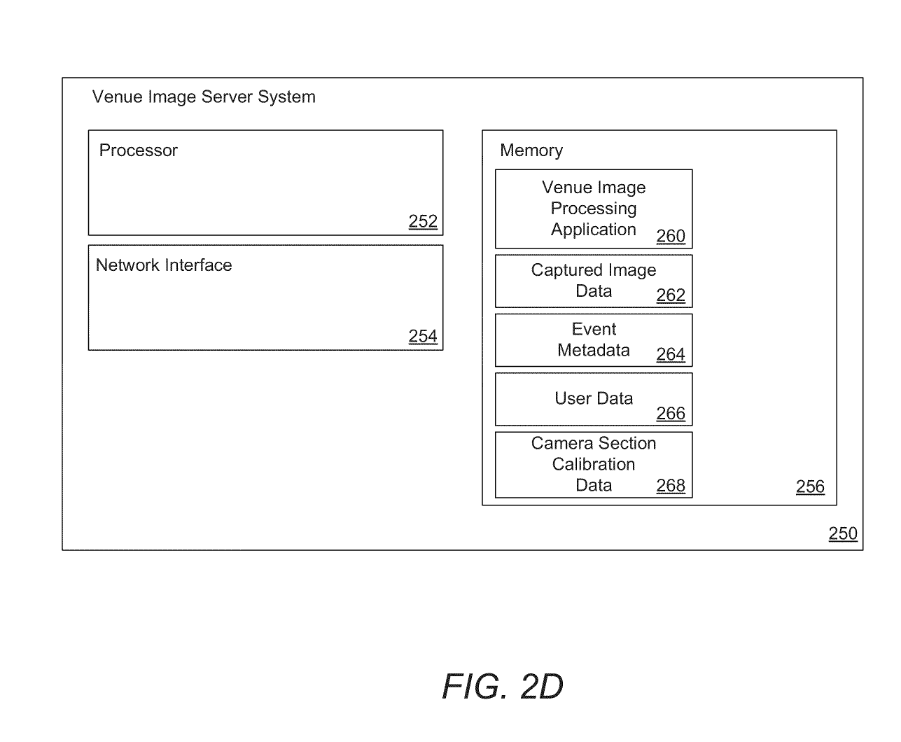

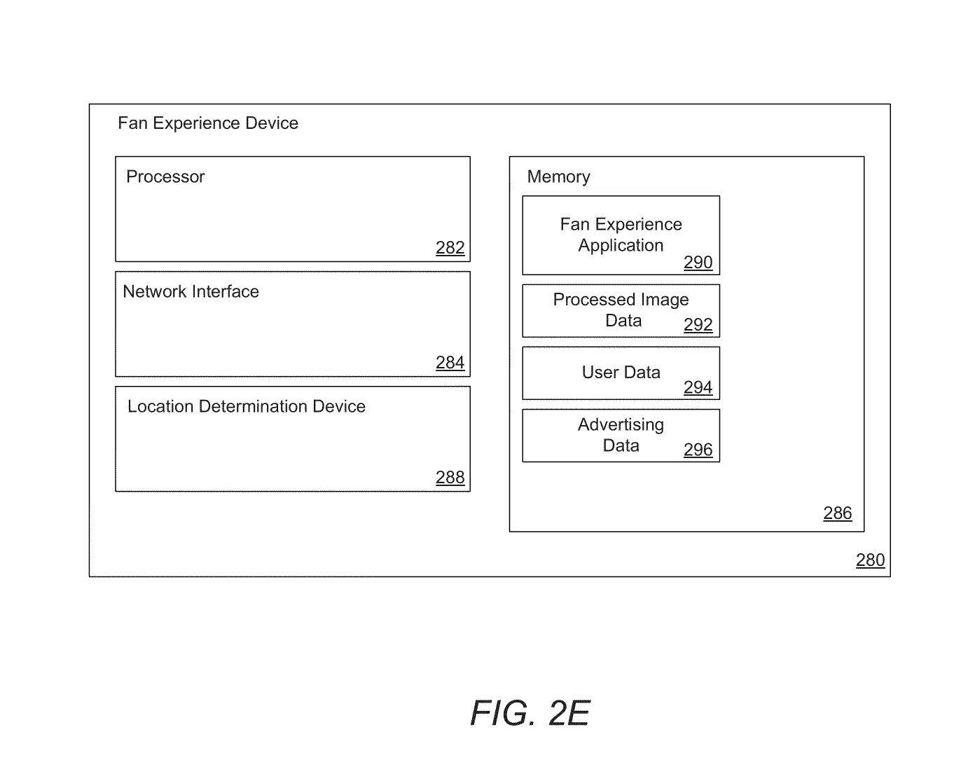

Venue image capture systems are designed to quickly capture moments that occur during events held at a venue, including a fan's reaction to the moment. Turning now to FIG. 2A, a conceptual illustration of a venue having a venue image capture system installed is shown. The venue 200 includes a set of camera systems 202 and a venue management server system 204. Each of the camera systems 202 are calibrated to capture images of a particular portion of the venue 200 as shown by sight lines 206. A camera system 202 can include a camera having an imaging sensor and lens. This can be a digital SLR camera, a digital camera, a device with custom imaging components, and/or a stripped down version of a camera unit that only requires certain features for image capture. The camera system is further designed to be secured to the venue 200 and includes mechanisms designed to rapidly accelerate and stop to move the camera through a sequence of camera positions. While in each position, the camera is configured to capture one or more images within the sight lines 206. In many embodiments, the structure of a camera system 202 can accommodate a wide range of cameras and lenses. Additional details regarding the camera systems 202 are described below with respect to FIGS. 2B and 2C. In several embodiments, the camera systems 202 are stationary.

The camera systems 202 are configured to have specific placements within the venue to ensure specific vantage points and optic requirements are abided to. For example, this can dictate the arrangement of the camera systems 202 and/or how the camera systems 202 are attached to the venue. In a number of embodiments, the venue management server system 204 (or any other device included in the venue image capture system) includes metadata describing the construction and/or layout of the venue 200 and makes recommendations regarding optimal camera placements based on the physical construction of the venue 200. These recommendations include determining locations for placing camera systems in order to obtain the best sight lines to particular sections of the venue, identifying locations for mounting camera systems that reduce the amount of vibration and/or movement experienced by the camera systems during events, identifying camera system locations that reduce the total number of camera systems installed in the venue 200, and/or any other recommendations as appropriate to the requirements of specific applications of the invention. The camera systems can also be attached to other infrastructure based in the venue such as a large format television installed in the venue, lighting platforms, and any other structures present in the venue.

In many embodiments, one or more camera systems 202 are installed using a suspended platform held by wires over the venue 200. The suspended platform can include a counter balance associated with one or more of the suspended camera systems that moves in the opposite direction during movements to cancel out any force that would lead to unwanted movement in the camera systems. Alternatively, multiple camera systems can be mounted on the same suspended platform and configured to move in concert to reduce the amount of unwanted movement experienced by each camera system. Accelerometers, active dampening devices, gimbals, and/or gyroscopes to can be utilized to stabilize the platform (thereby stabilizing the camera systems) as appropriate to the requirements of specific applications of embodiments of the invention.

In many embodiments, the venue manager server system 204 is configured to monitor the health of each of the camera systems 202. When a camera system 202 experiences problems, the venue manager server system 204 can issue a notification to the appropriate party to repair and/or replace the damaged camera system. Additionally, the venue manager server system 204 can include calibration data for each of the camera systems 202. In the event of a camera failure (or any other need), the venue manager server system 204 can transmit updated calibration data to any of the camera systems 202. In this way, the venue manager server system 204 can facilitate the reconfiguration of camera systems to capture a section of the venue that was originally covered by a failed camera system. This allows for the venue image capture system to provide images and/or advertising to fan experience devices even in the event of the failure of one or more camera systems. Additionally, the venue manager server system 204 can re-calibrate a camera system 202 in the event that some motion or other event occurs that results in the camera system becoming improperly calibrated during an event. Similarly, cameras in a peer-to-peer configuration can monitor and transmit their own health status to any appropriate system, such as by issuing alerts to a system administrator and/or a remotely managed venue management server system to warn of potential (or existing) problems. Additionally, cameras in a peer-to-peer arrangement can dynamically reconfigured themselves based on changes in the peer-to-peer network, e.g. when a camera system is added or removed from the peer-to-peer network as appropriate to the requirements of specific applications of embodiments of the invention.

### Camera Systems

Camera systems in accordance with embodiments of the invention are configured to be installed in various points within a venue. Once installed, the camera systems can be calibrated to capture images of varying sub-sections of the venue. In many embodiments, calibration data for a camera system is utilized to control the location and angle of the camera when capturing each sub-section and to describe how the camera system moves the camera between image captures. Turning now to FIG. 2B, a conceptual illustration of a camera system with a mounted camera and lens is shown. The camera system 220 includes a mounting plate 222 connected to a pan head tube 224. In a variety of embodiments, the mounting plate 222 is connected to the pan head tube 224 using vibration isolation components to reduce the amount of vibration transmitted from the structure of the venue to the pan head tube 224. The camera system 220 further includes a pan pulley 224 and a tilt pulley 228 with corresponding pan motor 232 and tilt motor 230. The pan pulley 224 and tilt pulley 228 are configured to adjust the tilt, pan, and/or angle of the camera assembly 234. In a variety of embodiments, the pan pullet 224 and/or tilt pulley 228 include physical and/or optical stops that prevent the camera from being moved to particular positions and/or to prevent the associated motors from moving beyond a pre-determined threshold. The camera assembly 234 further includes a camera body including an imager and a lens attached to the camera body. Any lens such as telephoto lenses, and camera bodies, such as digital single-lens reflex (DSLR) cameras, can be utilized as appropriate to the requirements of specific embodiments of the invention. In this way, a variety of lenses can be utilized for different camera systems in order to best capture the venue. Additionally, it should be noted that integrated (e.g. single piece) cameras, such as those that include a sensor array and a non-interchangeable lens integrated into the camera body, can be utilized in a variety of embodiments of the invention.

In many embodiments, the camera system 220 includes a camera controller configured to obtain image data from the camera assembly 234. The camera controller can be located in a variety of locations, including within the pan head tube 224 or external to the camera system 220 as appropriate to the requirements of specific applications of the invention. The camera controller can further be configured to transmit the image data to a venue manager server system and/or a venue image server system using a network connection. As described above, this network can be a LAN, a WAN, and/or the Internet and utilize any wired and/or wireless communication channels. For example, the camera controller can transmit the captured images to a venue manager server system using the local area network installed in the venue. By way of a second example, the camera controller can transmit the captured images directly to a venue image server system located outside of the venue using the Internet. A variety of metadata, including time data describing the time the image was captured and/or event metadata describing the event can be transmitted along with the captured images.

Additionally, the camera controller can store calibration data (e.g. camera calibration data) that configures the pan motor 232 and/or tilt motor 234 to move the camera assembly 234 through a variety of positions. Furthermore, the camera controller can directly control the camera assembly to adjust any properties of the camera (e.g. focus, color settings, light settings, etc. . . . ) and/or trigger the capture of images once the camera has reached a particular position. This triggering can be performed via software and/or by physically manipulating the buttons on the camera body. The camera controller can also determine information related to the overall health of the camera assembly 234 (e.g. images captures, etc. . . . ), the condition of the motors, and/or the overall physical health of the camera system 220 and generate camera system health data. This health data can be transmitted to venue manager server systems and/or venue image server systems for tracking and analysis of the condition of the camera system 220.

In many embodiments, the camera system 220 includes one or more sensors configured to measure a variety of conditions related to the camera system 220. In several embodiments, the camera system 220 includes an accelerometer configured to measure the movement of the camera assembly 234. In a number of embodiments, the camera system 220 includes a vibration sensor configured to measure the vibration of the camera assembly 234. The camera controller can utilize the data obtained using the one or more sensors to determine when the camera assembly 234 is stable enough to capture a clear image. In this way, the camera controller can adjust the triggering of the image capture based on both the location of the camera assembly 234 and the sensor data. In a variety of embodiments, the camera system 220 includes gyroscopes and/or any other stabilization device (both active and passive stabilization devices) configured to counteract any forces imparted to the camera system 220 from the venue and/or the external environment. In many embodiments, the camera controller can dynamically activate and/or deactivate the stabilization devices based on the sensor data. It should be noted, however, that any of a variety of sensors and stabilization devices not specifically described, such as servos and gimbals, can be utilized as appropriate to the requirements of specific applications of the invention. Additionally, the sensors can be utilized to trigger the capture of images. For example, a microphone can be utilized to determine when the ambient volume within the venue exceeds a threshold, thereby indicating that a moment could be occurring. A variety of microphone arrangements can be utilized in accordance with embodiments of the invention, such as a central microphone providing audio data to a plurality of camera systems and/or distributed microphone arrays providing audio data to one or more camera rigs. For example, the audio data from multiple microphones can be aggregated and, when the aggregate audio data exceeds a particular threshold, the camera systems are triggered. Additionally, a vibration sensor could be used to determine when the activity occurring within the venue exceeds a threshold, indicating that the fans may be standing and cheering and a moment has occurred. In a variety of embodiments, one or more camera systems determine that a moment is occurring and transmit a trigger signal to the network of camera systems in order to trigger a capture sequence of the entire venue. This technique is particularly useful when utilized with peer-to-peer camera systems.

If a camera system 220 is installed in outdoor conditions, weather may damage the camera assembly, the camera system itself, and/or any electronic components. In several embodiments, a casing that prevents weather-related damage is incorporated into the camera system 220. Any form of weather protection can be employed as appropriate to the requirements of specific embodiments of the invention, including, but not limited to, a cover that overhangs the camera system 220, a flexible waterproof material covering the camera system 220 that moves along with the movement of the camera system 220 and/or the camera assembly 234.

Turning now to FIG. 2C, a conceptual illustration of an alternative camera system with a mounted camera and lens in accordance with an embodiment of the invention is shown. The camera system 220′ includes hardware similar to that described above with respect to the camera system 220, including a mounting plate 222′ connected to a pan head tube 224′. In a variety of embodiments, the mounting plate 222′ is connected to the pan head tube 224′ using vibration isolation components to reduce the amount of vibration transmitted from the structure of the venue to the pan head tube 224′. The camera system 220′ further includes a pan pulley 224′ and a tilt pulley 228′ with corresponding pan motor 232′ and tilt motor 230′. The pan pulley 224′ and tilt pulley 228′ are configured to adjust the tilt, pan, and/or angle of the camera assembly 234′. In a variety of embodiments, the pan pullet 224′ and/or tilt pulley 228′ include physical and/or optical stops that prevent the camera from being moved to particular positions and/or to prevent the associated motors from moving beyond a pre-determined threshold. The camera assembly 234′ further includes a camera body including an imager and a lens attached to the camera body.

Although specific camera systems are described with respect to FIG. 2B and FIG. 2C, it should be noted that any camera system that is configured to obtain images of particular portions of a venue as described herein can be utilized as appropriate to the requirements of specific applications of embodiments of the invention.

### Venue Image Server Systems

Venue image server systems can be configured to obtain images captured during an event and process those images to highlight the fans reaction to each of the captured moments. The processed images can then be transmitted to fan experience devices. A venue image server system in accordance with an embodiment of the invention is conceptually illustrated in FIG. 2D. The venue image server system 250 includes a processor 252 in communication with memory 256. The memory 256 is any form of storage configured to store a variety of data, including, but not limited to, a venue image processing application 260, captured image data 262, event metadata 264, user data 266, and camera section calibration data 268. The venue image server system 250 also includes a network interface 254 configured to transmit data via one or more networks.

The venue image processing application configures the processor 252 to perform a variety of venue image processing processes. Venue image processing processes include obtaining captured image data 262 from camera systems and/or venue management server systems installed in a venue and/or camera section calibration data 268 describing the particular sub-sections of the venue being captured. Additionally, event metadata 264 describing one or more events associated with the captured image data 262 can be obtained. User data 266 describing demographic information, location information, engagement data, and historical event attendance for the fans attending the event can also be obtained. In a variety of embodiments, the user data 266 includes location information for the fan collected prior to attending the event, such as the type of transportation the fan took to the venue, where the fan parked, what time the fan arrived at the venue, and/or when the fan left the venue. Similarly, location information for the fan inside the venue including how much time the fan spent in their seat, how much time the fan spent waiting in lines for the bathroom and/or concessions, and/or how long the fan took to be served concessions. However, it should be noted that any other data related to fans can be included in user data 266 as appropriate to the requirements of specific applications of the invention.

The image data 262 can include still images, video and/or audio data as appropriate to the requirements of specific applications of the invention. Venue image processing processes further include processing the captured image data 262 to highlight the moment for each fan present in the captured image. In a variety of embodiments, the camera section calibration data 268 is utilized to identify seat locations within the captured image data 262; these seat locations are then utilized to provide cropping locations for removing unwanted portions of the captured image data 262 for each fan. Event metadata 264 can be associated with the processed images to provide context to the moment being captured. Event metadata includes, but is not limited to, a game score, the teams playing in a sporting event, the performer at an event, the time the moment occurred, the location of the event, a description of the event, and any other data as appropriate to the requirements of specific applications of the invention. The event metadata, the camera calibration data, and the captured image data can be synchronized using any appropriate synchronization technique, such as timestamp matching, assigning unique codes to each moment, or any other technique for aligning disparate pieces of data for a particular moment.

The user metadata 266 can be utilized to identify the fan that is being shown in the processed images. In this way, the user metadata 266 can be used to identify the fan experience device associated with a particular seat so that the processed images can be transmitted to the appropriate fan. Additionally, the user metadata can include demographic data, historical event attendance data, online social network data, usage data, advertisement display data, advertisement engagement data, location information, and/or any other data describing the fan as appropriate to the requirements of specific applications of the invention. The captured image data 262, event metadata 264, user data 266, and/or camera section calibration data 268 can be utilized to target advertisements to specific fans attending an event. Techniques for targeting advertising in accordance with embodiments of the invention are described in more detail below.

### Fan Experience Devices

Fan experience devices can be configured to present images, video, and audio capturing moments to fans both during and after an event. Many of these images capture the fan's reaction to moments occurring during the event, while other images can provide mementos of memorable moments occurring during the event. Fan experience devices can be used to share the images via the fan experience application itself and/or via online social networks. Turning now to FIG. 2E, a fan experience device in accordance with an embodiment of the invention is conceptually illustrated. The fan experience device includes a processor 282 in communication with memory 286. The memory 286 is any form of storage configured to store a variety of data, including, but not limited to, a fan experience application 290, processed image data 292, user data 294, and advertising data 296. The fan experience device 280 also includes a network interface 284 configured to transmit data via one or more networks. In many embodiments, the fan experience device 280 includes a location determination device 288, such as a global positioning system (GPS) receiver, configured to determine the location of the fan experience device.

The fan experience application 290 configures the processor 280 to perform fan experience processes. Fan experience processes include obtaining processed image data 292 including event metadata describing the moment captured in the processed image data. The processed image and/or event metadata can then be displayed using the fan experience device. Fan experience processes can also include manipulating the processed image data such as by applying a visual filter and/or associating text data, audio data, additional image data, and/or video data with the processed image data. For example, the fan can add a caption to a captured moment. In many embodiments, fans can select one or more captured moments and purchase a print copy of the image. Fan experience processes can further include sharing the processed image data via one or more online social networks, including any additional metadata that has been associated with the processed image data.

In several embodiments, fans attending the event can utilize fan experience devices to capture images during the event. These fan-generated images can be incorporated into the set of processed images transmitted to the fan experience device. Additionally, images taken in the venue (such as official photographs of the event) can also be incorporated into the processed images transmitted to fan experience devices. Any of the images on a fan experience device can be transmitted using third-party services and/or transmitted to a variety of fan experience devices in accordance with embodiments of the invention such as those described below. Additionally, the images captured using the camera systems, venue images, and/or fan-generated images can be transmitted to a video display system present in the arena and displayed. For example, fan-generated images can be displayed using the in-venue video system to provide a user-generated kiss cam experience.

Additionally, advertising data 296 can be obtained and displayed using the fan experience device. The advertising data can be displayed in addition to the processed image data and/or during periods when processed image data is not being displayed. This advertising data can be specifically targeted to the fan experience device based on the user data 294, the location of the fan experience device, and/or event metadata describing the particular moment being shown in the processed image data 292. In a variety of embodiments, user data 294 contains demographic information, location information, engagement data, and historical event attendance for the fan associated with the fan experience device 280. Any other data related to fans can be included in user data 294, including the user data described above, as appropriate to the requirements of specific applications of the invention. Engagement with the advertising data can be tracked and used to provide feedback to the advertisers and/or in the targeting of advertising to a particular fan. Additionally, fan experience devices can track user engagement with a variety of applications installed on the fan experience device. The engagement with other applications can be utilized to target advertising and/or drive engagement with the fan experience device.

Although a specific architectures for venue image capture systems and various devices within the venue image capture system in accordance with an embodiment of the invention is conceptually illustrated in FIGS. 2A-2E, any of a variety of architectures, including those that store data or applications on disk or some other form of storage and are loaded into memory at runtime, can also be utilized. Processes for capturing and distributing images during an event in accordance with embodiments of the invention are discussed further below.

### Capturing and Distributing Images

During an event, camera systems can be configured to capture a variety of images when a moment occurs. These moments can include anything that invokes a reaction from the fans. Camera systems installed throughout the venue can be configured to be triggered (such as by obtaining a piece of trigger data) to capture a sequence of images of the fans reacting to the moment. These images each capture a particular sub-section of the venue; these sub-sections can be overlapping and/or distinct depending on the layout and calibration of the camera systems. These images can then be processed and distributed to a variety of fan experience devices. Multiple versions of the images can be captured by the camera systems, such as RAW images and compressed images. Additionally, the captured images can be compressed to reduce file size before being transmitted to a venue manager server system and/or a venue image server system. In many embodiments, an index image is transmitted; this index image can be utilized in the processing of the images and/or to provide a sample image that can be utilized to determine if the entire sequence of captured images should be transmitted and/or processed. Image correction can be applied to some or all of the captured images to adjust pixels, repair focus, adjust the contrast, exposure, saturation, or any other corrections that conform to the requirements of specific applications in accordance with embodiments of the invention. In a variety of embodiments, the calibration of the cameras is utilized to perform corrective manipulations. These corrective manipulations can adjust the captured images so that the fans are better captured in the image and/or facilitate additional processing of the images. The images can be processed in order to capture each fan's reaction to the moment. In a variety of embodiments, metadata describing the moment and/or the event are associated with the processed images to provide more details regarding the moment being captured. Additionally, performance information describing the number of triggers initiated can be tracked. For example, the number of triggers to capture moments can be compared to the total number of moments occurring within the event can be tracked. In this way, the performance of the venue image capture system can be measured. By identifying missed opportunities, the future performance of the venue image capture system, such as the number of moments captured, the placement of the camera systems, and the calibration of the camera systems, can be improved.

The processed images along with the event metadata (if applicable) can be provided to one or more fan experience devices. The processed images identify a particular seat and the images are transmitted to the fan experience device associated with that seat. By way of example, a fan can provide her location data (e.g., their assigned or current seat number, or mobile device location information (e.g., GPS location)) using a fan experience device; the venue image server system obtains that information from the fan experience device and uses that information to transmit the appropriate images to the fan experience device. Images can be provided to the fan experience devices at a variety of distribution opportunities, such as during breaks in an event (e.g. timeouts, halftime, intermissions, etc. . . . ), on a request from a fan experience device, when the processing of the captured images is complete, after the event is completed, and/or at any other time as appropriate to the requirements of specific applications in accordance with embodiments of the invention. In many embodiments, distribution opportunities are selected based on engagement with the fan experience device. In this way, fans that demonstrate high utilization of the system can receive more images than those fans that utilize the system less. Similarly, fans with low engagement can receive additional images in an effort to increase their utilization of the system.

Advertising can also be targeted to the fan experience devices and transmitted to the fan experience device. The advertising data can be displayed using the fan experience device during periods when the fan is not viewing an image and/or in conjunction with the displayed images. The images can also be shared to a variety of third-party sites, such as online social networks, to be shared with those in contact with the fan. In a variety of embodiments, fans can provide feedback regarding the received images. In cases where the wrong images are being transmitted to a fan experience device, the feedback data can be utilized to identify the correct images to be transmitted to the fan experience device. In several embodiments, engagement with the fan experience device, such as online social network shares, images captured via the fan experience device, installations of the fan experience application on a fan experience device, usage metrics related to the fan experience device, and/or engagement with advertising presented using the fan experience device can be logged. This engagement data can be utilized in a variety of ways including, but not limited to, improving the application, engagement with the application, and/or targeting of advertising as described in more detail below.

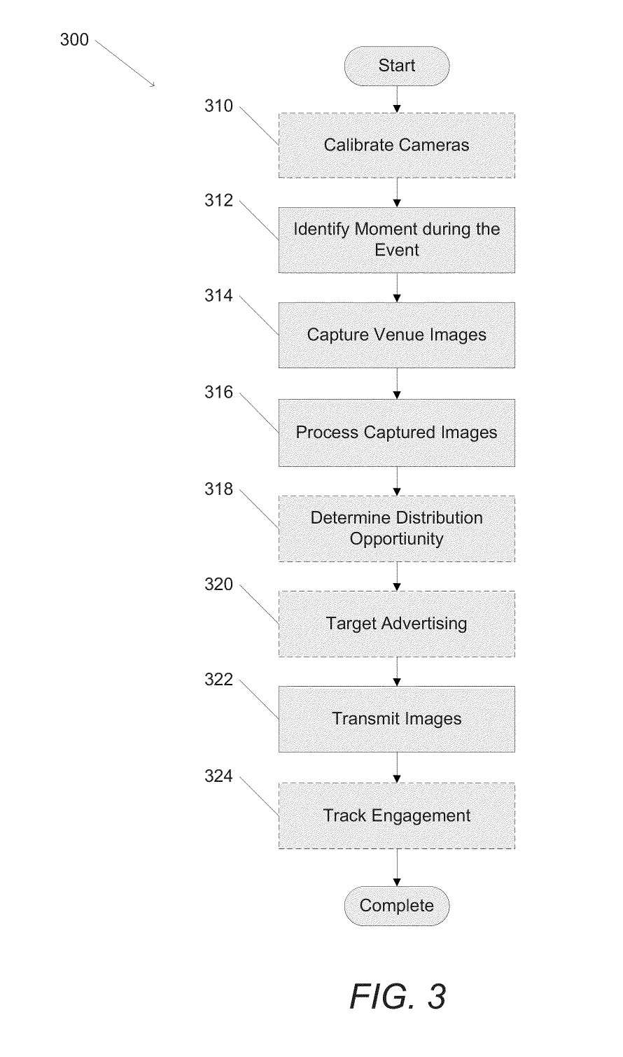

Turning now to FIG. 3, a flow chart conceptually illustrating a process for capturing and distributing images captured during a venue event in accordance with an embodiment of the invention is shown. In a variety of embodiments, the process 300 includes calibrating (310) cameras. An event is identified (312) and venue images are captured (314). Captured images are processed (316) and in a number of embodiments distributed opportunities are determined (318) and/or advertising is targeted (320). Images are then transmitted (322) and, in several embodiments, engagement is tracked (324). Although specific processes for capturing and distributing images captured during a venue event in accordance with an embodiment of the invention is described above, any of a variety of processes, including those that distribute images on-demand or target advertising after the images have been transmitted can also be utilized. Processes for calibrating cameras and camera systems in accordance with embodiments of the invention are discussed further below.

### Calibrating Cameras

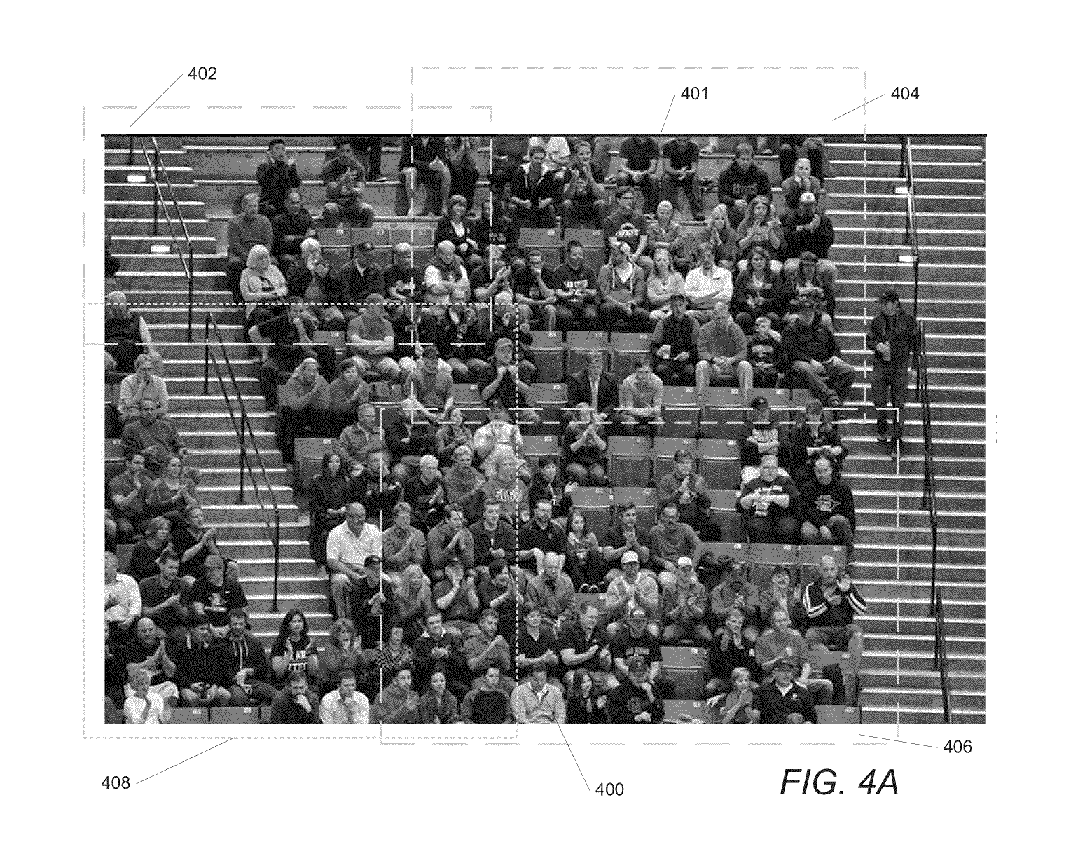

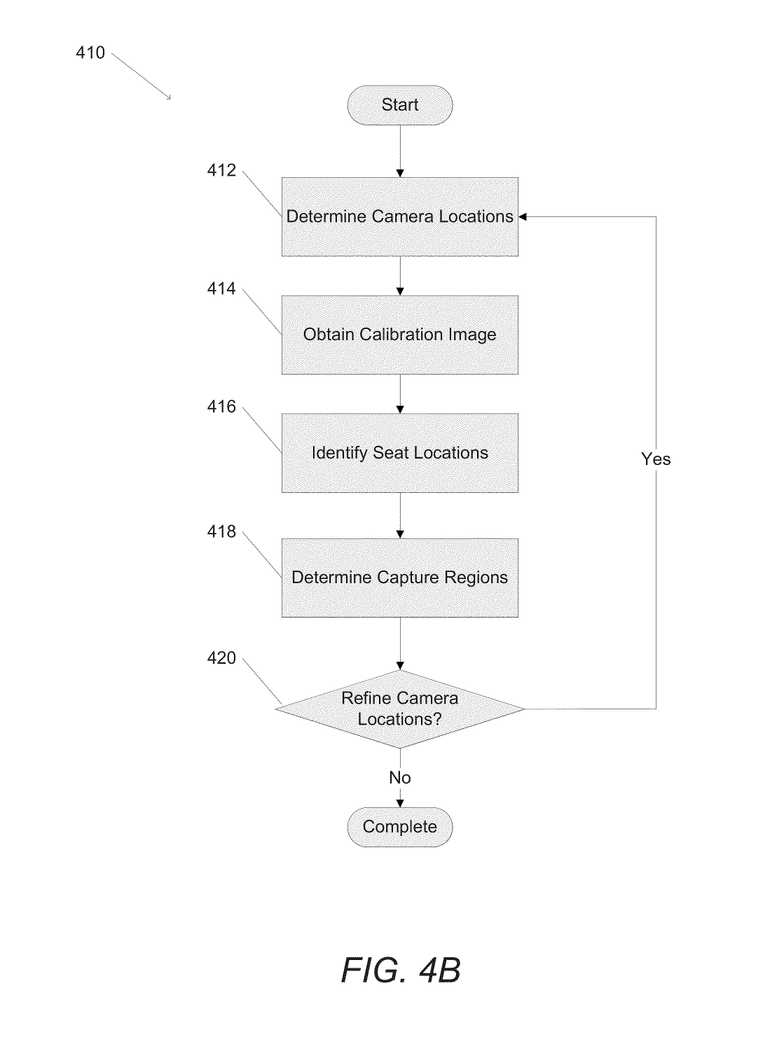

A variety of camera systems can be installed in a venue. In order to get coverage of the venue with the least number of camera systems, the camera systems can be configured to adjust the orientation of the camera assemblies. In many embodiments, fixed camera systems are installed in locations that provide coverage of the venue. This allows the camera assemblies to capture the best quality images of the sub-section of the venue assigned to the camera system. In several embodiments, calibrating the camera systems include determining the most applicable lens to affix to the camera body. In this way, a variety of camera lenses can be utilized in order to provide the best variety of images to cover the venue. In a variety of embodiments, camera systems are calibrated to have a pre-defined capture sequence. The capture sequence can include a set of locations and a set of camera configurations. Turning now to FIG. 4A, a set of capture regions for a particular sub-section of a venue is conceptually illustrated. The sub-section 400 includes a plurality of seats 401 that are within the capture region defined for a particular camera system. The camera system is configured to capture four images of the sub-section 400; these images correspond to capture regions 402, 404, 406, and 408. In a variety of embodiments, the capture regions are defined so that the angle of the camera relative to the capture region results in an image of that capture region best showing the fans in that capture region. The capture regions can overlap to ensure that as many seats as possible in the sub-section 400 are within the capture region of the camera system. The capture sequence can configure the camera system to move the camera assembly into position to capture an image of each capture region and can trigger the capture of that image once the camera assembly has been moved into position. In a variety of embodiments, the camera system is configured to begin each capture sequence from the same starting position. In many embodiments, the camera system is configured to start the capture sequence at the current location within the capture sequence and/or at a random location (e.g. a roaming location within the capture sequence) within the capture sequence. In this way, even coverage of the sub-section can be captured throughout the event. This is particularly relevant in those embodiments with long capture sequences, such as those that cannot be completed during the duration of some moments. In this way, every fan within the sub-section will have some images captured, if not for every moment occurring during the event.

A camera configuration includes, but is not limited to, setting the white balance, film speed (e.g. ISO settings), focus, color temperature, capture speed, exposure, shutter speed, f-stop, depth of field, zoom, and/or any other parameter that can be adjusted on a camera assembly. At each location in the sequence, the camera assembly is reconfigured and an image is captured. The camera configurations can be pre-determined and/or determined dynamically based on the conditions in the venue when the moment is captured. When a capture sequence is triggered (such as in response to a moment occurring within the event), the camera system proceeds through the camera sequence and captures a set of images. These captured images can be transmitted directly to a venue image server system by the camera system and/or to a venue manager server system installed in the venue. Additionally, event metadata, such as the time the images were captured, can be associated with the captured images and transmitted accordingly.

The calibration data for a particular camera system can be stored locally on the camera system and/or transmitted to the camera system via a venue manager server system. This allows for the camera systems to be re-calibrated in real time to compensate for changes in the venue and/or failed camera systems. Additionally, the venue manager server system can display the calibration information for multiple camera systems simultaneously, providing a broad view of the coverage of the arena. This can facilitate the calibration of the camera systems by quickly identifying those areas of the stadium that could utilize additional camera coverage.

Turning now to FIG. 4B, a flow chart conceptually illustrating a process for calibrating a camera system in accordance with an embodiment of the invention is shown. The process 410 includes determining (412) camera locations and obtaining (414) calibration images. Seat locations are identified (416) and capture regions are determined (418). If the camera locations need to be refined (420), camera locations are determined (412). Specific processes for calibrating camera systems in accordance with an embodiment of the invention is conceptually illustrated in FIGS. 4A and 4B; however, any of a variety of processes, including those that capture alternative and/or non-overlapping sub-sections and/or images of the event during particular moments can also be utilized. Processes for capturing images of moments during an event in accordance with embodiments of the invention are discussed further below.

### Capturing Images of a Moment

When a moment occurs during an event, the camera systems installed in the venue can be triggered to proceed through their capture sequences. The triggering of the modules can be initiated in one or more of a variety of ways, such as by an operator (or operators) watching the event or/and the crowd who indicated when a moment occurs. The trigger can be a radio signaled device or a mobile or computer device that transmit a trigger instruction to the camera systems. In many embodiments, movement-monitoring sensors targeted toward on sections of the crowd initiate a trigger when the crowd movement is sufficient to indicate a moment. In a number of embodiments, the camera systems are configured to determine when a moment occurs and trigger themselves to capture that moment. In a variety of embodiments, the camera systems can be triggered by a fan experience device. For example, a fan can trigger an image capture, the appropriate camera system(s) can capture an image of the fan, and a processed photo of the fan can be transmitted to the appropriate fan experience device. Furthermore, the trigger can be fired by pre-installed monitoring systems that can correspond to a moment such as goal-line technology, lighting, etc. . . . Other triggering techniques can be utilized as appropriate to the requirements of specific applications of the invention. Additionally, the trigger can be a continuous capture trigger that instructs the camera systems to repeatedly proceed through their capture sequence until a stop trigger is received. In this way, a variety of moments can be captured, such as to moments with a long duration and/or several moments that occur in quick succession. Once captured, the images can be transmitted utilizing techniques similar to those described above. In many embodiments, the images are transferred directly to a venue image server system by the camera systems. In several embodiments, the images are aggregated using a venue management server system. In this way, some pre-processing, filtering, and/or aggregation of the images can be performed before transmitting the images to the venue image server system. This can help reduce the processing demands on the venue image server system and/or improve the usage of the bandwidth of the venue's Internet connection.

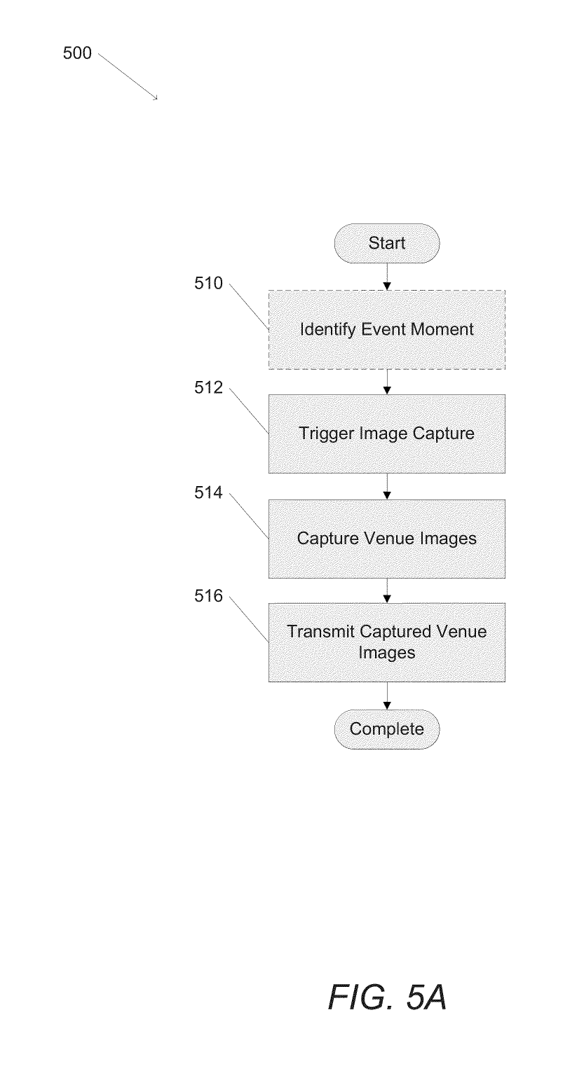

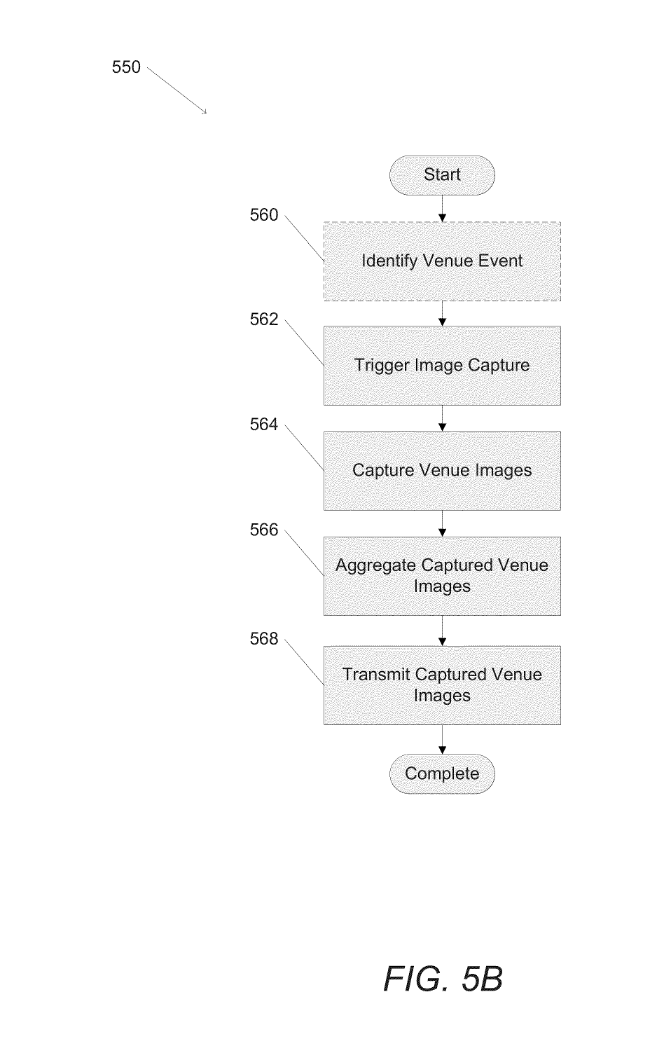

Turning now to FIG. 5A, a flow chart conceptually illustrating a process for capturing images of a moment in accordance with an embodiment of the invention is shown. In several embodiments, the process 500 includes identifying (510) an event moment. Image capture is triggered (512), venue images are captured (514), and venue images are transmitted (516). Turning now to FIG. 5B, a flow chart conceptually illustrating a process for capturing images of a moment utilizing a venue manager server system in accordance with an embodiment of the invention is shown. In a number of embodiments, the process 550 includes identifying (560) an event moment. Image capture is triggered (562), venue images are captured (564), the captured images are aggregated (566), and venue images are transmitted (568).

Although specific processes for capturing images of a moment in accordance with an embodiment of the invention is conceptually illustrated in FIGS. 5A and 5B, any of a variety of processes, including those that process the images prior to transmitting them can also be utilized. Processes for identifying moments within the captured images in accordance with embodiments of the invention are discussed further below.

### Identifying Moments

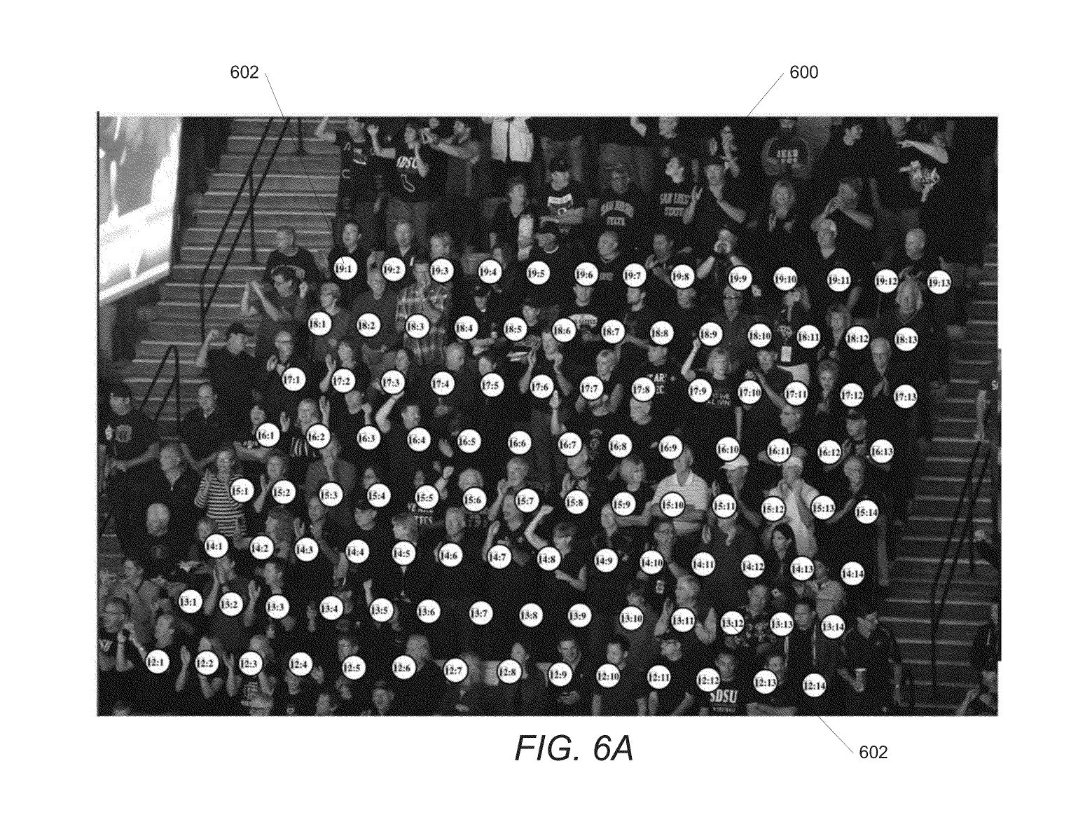

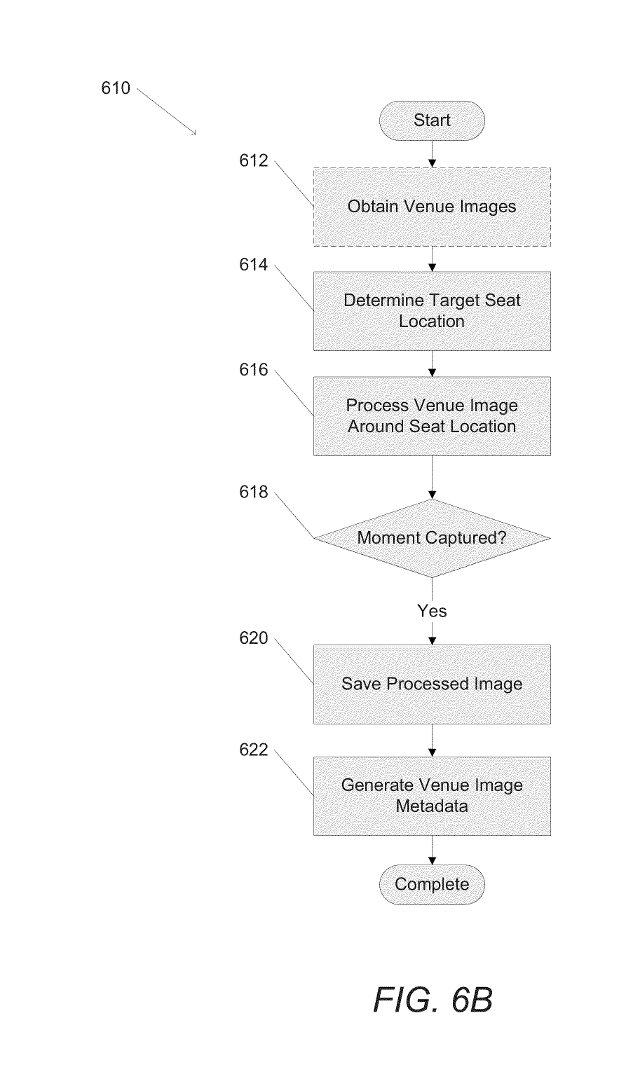

Once an image of a sub-section is captured, the reaction of each fan in that section can be identified and highlighted. In this way, the captured images can be processed to create a set of processed images having each fan's reaction. Metadata describing the event can then be associated with the processed images providing additional insights into the moment. Turning now to FIG. 6A, a template for identifying seat locations within a captured image in accordance with an embodiment of the invention is conceptually illustrated. The seat template 600 includes a plurality of seat identifiers 602. Each seat identifier corresponds to a seat within the sub-section. In many embodiments, the seat template 600 corresponds to a particular capture region within a sub-section for a given camera system. In this way, every image captured by the camera system can be accurately processed. In a number of embodiments, the captured images are corrected to facilitate the processing of the captured image according to the seat template 600. In several embodiments, the correction applied to the captured image includes a perspective correction based on the calibration information associated with the camera system and/or camera assembly at the time the image was captured.

In a number of embodiments, a crowd of fans may not be associated with a particular seat. For example, the floor section of a concert commonly does not contain assigned seats; rather, the fans are free to move about in a defined region. Similarly, the bleacher sections of many stadiums are a first-come, first-served environment. In order to identify the fans within a crowd, location determination devices contained within the fan experience devices can be utilized to determine the location of a particular fan within the crowd at any given moment during an event. Captured images of the crowd can then be tagged with metadata describing the time the image was captured. The location data and the captured images (e.g. location data describing one or more locations of the region of the venue where the crowd is being captured) can be correlated in order to identify the location of a particular fan within the captured image. In this way, the location data and the captured images can be utilized to generate a seat template for the crowd captured in the image.

A variety of techniques can be utilized to process the captured images. In several embodiments, the seat identifiers 602 are utilized as a crop point and the processed image is generated by cropping the captured image according to one or more cropping templates based around the crop point. In several embodiments, the cropped images can then be reviewed and the best image(s) can be selected to use as the processed image. In many embodiments, features are identified within a region proximate to a seat identifier 602 and that feature is utilized as the basis for generating the processed image from the captured image. This can lead to processed images having particular features within the processed image at desired locations of interest. In a number of embodiments, the seat identifiers 602 correspond to the physical seat locations within the venue, that is, to the section, row, and seat numbers present on a ticket. This allows for the seat identifiers 602 to be included in the metadata associated with the processed image so that the processed images are automatically tagged with the appropriate seat, thereby facilitating the delivery of the processed image to the fan experience devices corresponding to the identified seat.

Additionally, information regarding the content of the captured image can be included as metadata. Similarly, if there are technical and/or safety issues captured in the images, those can be flagged for the venue staff to address. In a number of embodiments, players and other performers are present in the captured images. Metadata describing the players and/or moment captured in the image can be included for later display on fan experience devices.

Turning now to FIG. 6B, a flow chart conceptually illustrating a process for identifying moments in captured images in accordance with an embodiment of the invention is shown. In many embodiments, the process 610 includes obtaining (612) venue images. Target seat locations are determined (614) and venue images are processed (616) around target set locations. If a moment is captured (618), the processed images are saved (620) and venue image metadata is generated (622). Specific processes for identifying moments in captured images in accordance with an embodiment of the invention is conceptually illustrated in FIGS. 6A and 6B; however, any of a variety of processes, including those that utilize alternative processing techniques to extract particular fan reactions to a moment, can also be utilized in accordance with embodiments of the invention. Processes for distributing images in accordance with embodiments of the invention are discussed further below.

### Distributing Images

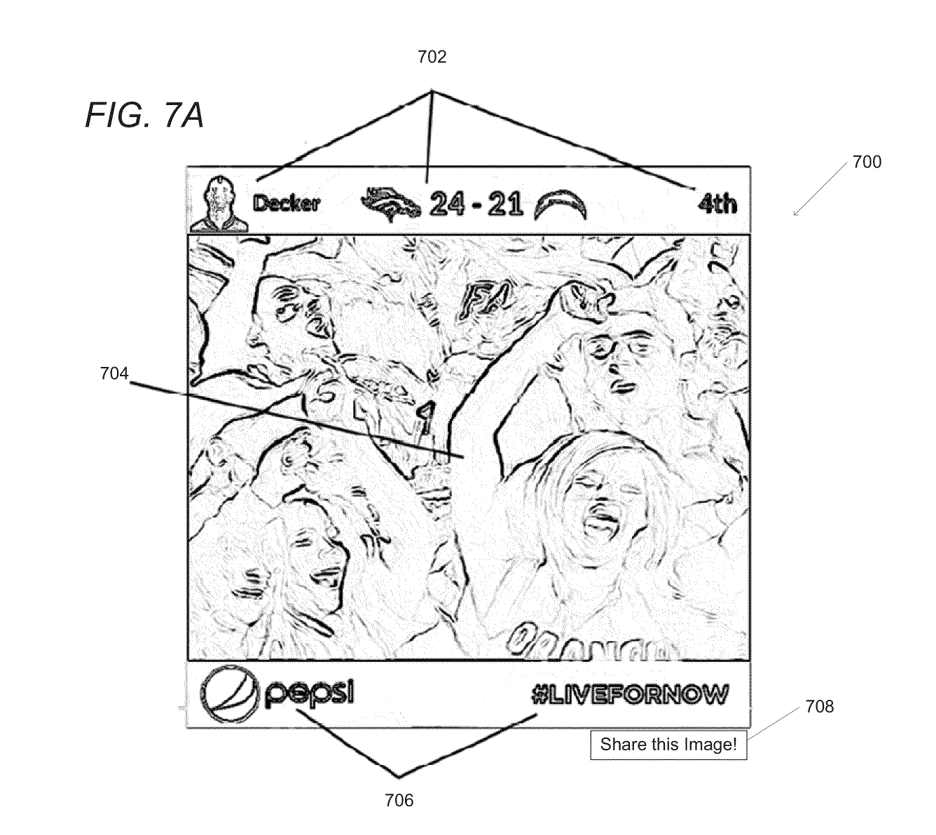

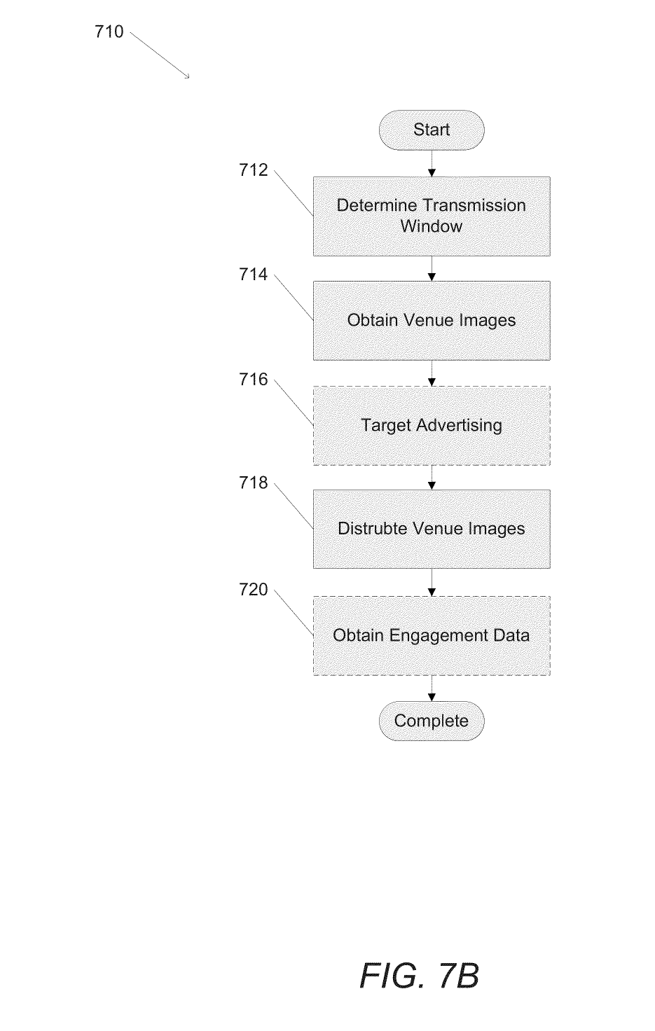

Once the images are processed and the appropriate metadata associated with the images, the processed images can then be transmitted to the appropriate fan experience devices. As described above, the processed images can be displayed along with metadata describing the event and/or moment along with advertising targeted toward the fan experience device and/or the user of the fan experience device. Turning now to FIG. 7A, a conceptual illustration of a user interface for viewing a processed image in accordance with an embodiment of the invention is shown. The user interface 700 includes a processed image 704 along with event metadata 702 and targeted advertising 706. The processed image 704 includes an image of the fan reacting to a moment that occurred during the event. The event metadata 702 describes the moment that occurred. Techniques for targeting the advertising 706 are described in more detail below. The advertising can include, but is not limited to, image data, text data, video data, audio data, and/or any other advertising data that can be displayed using a fan experience device. Additionally, a social sharing button 708 is provided that allows the user to share the image and/or event metadata. The image and/or event metadata can be shared via one or more online social networks, to other fan experience devices, and/or on any other system as appropriate to the requirements of specific applications of the invention.

Any of a number of metrics related to the display and engagement of content within the fan engagement application can be tracked as appropriate to the requirements of specific embodiments of the invention. These metrics can be related to the display and viewing of processed images 704 such as, but not limited to, the number of images viewed by the fan, the time spent viewing the images, the number of times the fan checks for new images, the time taken to transmit the images to the fan experience device, images taken using the fan experience device, and/or any other usage-related metrics. The metrics can also be related to the event metadata 702 including, but not limited to, identifying the time in the event the fan checks for moments, the number of moments the fan receives a processed image for, and/or any other event-related data. Furthermore, engagement can be measured with respect to the sharing of processed images to one or more online social networks using the social sharing button 708 and/or the performance of the online social network post can be tracked. Additionally, these metrics can be aggregated and analyzed across a number of fan experience devices.

Turning now to FIG. 7B, a flow chart conceptually illustrating a process for distributing images to fan engagement devices in accordance with an embodiment of the invention is shown. The process 710 includes determining (712) a transmission window and obtaining (714) venue images. In a number of embodiments, advertising is targeted (716). Venue images are distributed (718) and, in several embodiments, engagement data is obtained (720). Although specific processes for distributing images to fan engagement devices in accordance with an embodiment of the invention is conceptually illustrated in FIGS. 7A and 7B, any of a variety of processes, including those that distribute images to fan engagement devices after the event has concluded can also be utilized. Processes for targeting advertising in accordance with embodiments of the invention are discussed further below.

### Targeting Advertising

Fans attending an event present a unique advertising opportunity. Because the fans present a captive audience with easily identifiable interests, this data can be utilized to effectively identify and target advertising to those fans. For example, if hockey fans are generally interested in a particular brand of automobile, advertising presented to fans attending a hockey game at a venue are likely to be very interested in advertising for that brand of automobile. This can lead to increased engagement with the advertisements and a higher than average rate of conversions for that advertising. Additionally, advertising can be targeted to encourage venue-based sales and to assist with preventing queues at concessions by encouraging users to purchase goods at certain times and at certain locations. In a variety of embodiments, location information (e.g. the fan's seat location) can be utilized to facilitate in-seat service. Fans can place orders using their fan experience device and have those goods delivered directly to their seats by the in-venue vendors. The targeting information can also be influenced by particular moments that occur within an event, demographic information for the fans of the event, the location of the event, the time the event begins and/or ends, businesses in the vicinity of the venue, previous events attended by the fan, and/or any other targeting data appropriate to the requirements in accordance with specific applications of the invention. Demographic information can be based on the expected distribution of fans attending the event and/or personalized based on the user data associated with the fan as provided by the fan experience device. In this way, different ads can be targeted toward different fans attending the same event. Additionally, the user data can include metadata describing the advertisements previously viewed and/or engaged with by the fan. In this way, the advertising targeted toward the fan can be tailored toward the interests expressed by the fan. In many embodiments, metadata describing the fan's behavior on one or more online social networks can be utilized in the targeting of advertisements. This allows for advertising relevant to the fan's expressed interests outside of the venue to be presented using the fan experience device. Additionally, data describing fan engagement with previously targeted advertisements and with the fan engagement device itself can be utilized in the targeting of future advertising. For example, if the fan uses the in-venue ordering service to order particular goods, advertisements for those goods and/or related goods can be targeted to the user. Similarly, competitive ads can be displayed in an effort to lure that fan to a different brand of product.

In several embodiments, targeting information can also be modified based on various agreements in place with the venue and/or the event. In this way, the advertisements targeted toward a particular fan can be harmonized with the obligations of the venue and/or event. For example, if a fan has an expressed preference for Coke but the venue has an agreement to only sell Pepsi products, advertisements other than Pepsi advertisements can be targeted to that fan as the display of Pepsi advertisements is unlikely to result in further engagement with those advertisements. Similarly, advertisements for competitors to those products that fans have expressed an affinity for can be targeted to those fans to influence the fans to purchase the competitor's products. This also allows the venue image capture system to only present advertisements that are in accord with the agreements in place with the events and the venues in which the system is installed. Returning to the previous example, if the venue has an exclusive agreement to sell Pepsi products, advertisements for Coke products can be excluded from those advertisements shown to fans via fan engagement devices.

The advertisements can be hosted and transmitted directly by any of a variety of systems within a venue image capture system, such as by a venue manager server system and/or a venue image server system. However, the targeting information can be transmitted to third-party advertising systems that provide targeted advertising to the fan experience devices can also be utilized in accordance with many embodiments of the invention.

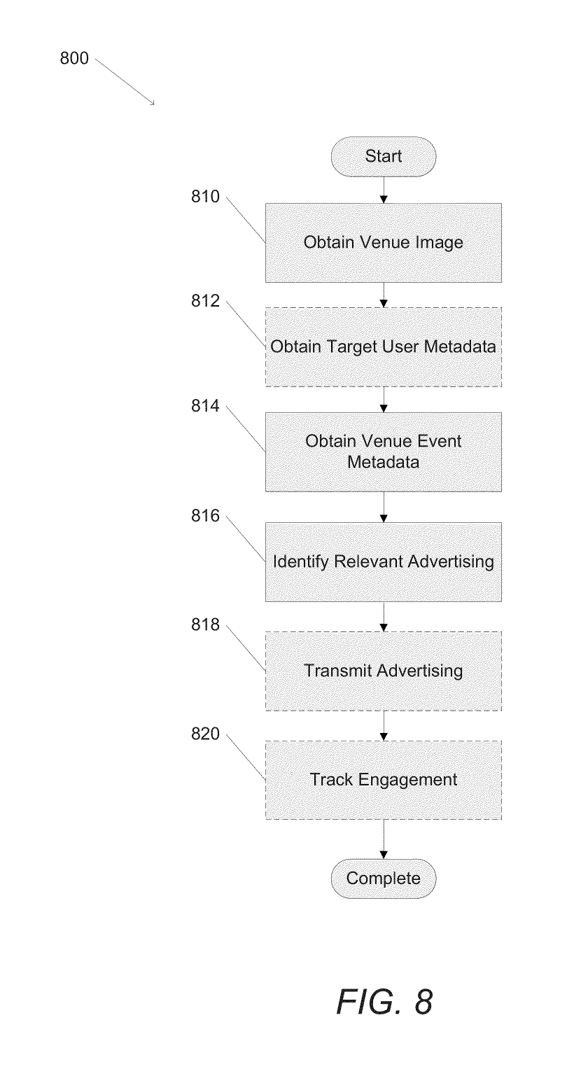

Turning now to FIG. 8, a flow chart conceptually illustrating a process for targeting adverting to fan engagement devices in accordance with an embodiment of the invention is shown. The process 800 includes obtaining (810) venue images and, in several embodiments, obtaining (812) target user metadata. Venue event metadata is obtained (814) and relevant advertising is identified (816). In a variety of embodiments, advertising is transmitted (818) and/or engagement with the advertising is tracked (820). Specific processes for targeting advertising in accordance with an embodiment of the invention is conceptually illustrated in FIG. 8; however, any of a variety of processes, including those that provide targeting information to third-party advertising servers that deliver the targeted advertising content can also be utilized. Additionally, it should be noted that any custom content can be incorporated into the transmission and display of processed images as appropriate to the requirements of specific applications of embodiments of the invention.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A venue image capture system, comprising:
a set of camera systems installed in a venue; and
a set of fan experience devices;
wherein a camera system in the set of camera systems comprises:
a camera comprising an imager configured to capture image data; and
a camera controller configured to:
obtain trigger data; and
configure the camera to capture an image;
wherein a camera system in the set of camera systems is configured to:
obtain a piece of trigger data;
capture a set of images in response to the trigger data, where the set of images captures a sub-section of the venue; and
transmit the set of images; and
wherein a fan experience device comprises:
a processor; and
a memory connected to the processor and configured to store a fan experience application; and
wherein the fan experience application configures the processor to:
determine fan experience device location data;
obtain processed image data, wherein:
the processed image data comprises image data and metadata identifying the location captured in the processed image data; and
the location captured in the obtained processed image data corresponds to the determined fan experience device location data; and
display the obtained processed image data.

2. The venue image capture system of claim 1, wherein a camera system in the set of camera system further comprises calibration data that configures the camera controller to move the camera between a set of pre-defined positions during the capture of a set of images.

3. The venue image capture system of claim 2, wherein a camera system in the set of camera systems further comprises:
a mounting plate configured to attach the camera system to the venue;
a pan pulley configured to adjust the pan of the camera; and
a tilt pulley configured to adjust the tilt of the camera;
wherein the camera controller is configured to adjust the position of the camera using the pan pulley and the tilt pulley.

4. The venue image capture system of claim 2, wherein the camera controller is configured to obtain a second piece of trigger data indicating that the camera system should stop capturing images.

5. The venue image capture system of claim 4, wherein the camera controller is configured to:
store the last position of the camera in response to obtaining the second piece of trigger data;
stop capturing images in response to obtaining the second piece of trigger data; and
when the camera controller receives a third piece of trigger data, start capturing images beginning from the stored last position in the set of pre-defined positions.

6. The venue image capture system of claim 2, wherein the camera controller is configured to start capturing a set of images beginning from a roaming position in the set of pre-defined positions.

7. The venue image capture system of claim 2, wherein:
the camera system further comprises movement sensors configured to measure the movement of the camera; and
wherein the camera controller is configured to capture an image in the set of images when the movement of the camera is below a threshold value.

8. The venue image capture system of claim 2, wherein the camera system further comprises a gyroscope configured to stabilize the camera system.

9. The venue image capture system of claim 1, further comprising a venue manager server system, wherein:
each camera system is configured to transmit camera system health data to the venue manager server system; and
the venue manager server system is configured to generate an administrative interface based on the camera system health data.

10. The venue image capture system of claim 9, wherein the venue manager server system is further configured to:
identify when a camera system in the set of camera systems has failed;
determine a subset of the camera systems in the set of camera systems that can provide coverage of the failed camera system; and
reconfigure the subset of camera systems in the set of camera systems to cover the sub-section of the venue covered by the failed camera system.

11. The venue image capture system of claim 10, wherein the venue manager server system reconfigures a camera system by transmitting updated camera calibration data to each camera system in the subset of camera systems.

12. The venue image capture system of claim 11, wherein the venue manager server system is configured to dynamically generate the updated camera calibration data based on the camera system health data.

13. The venue image capture system of claim 9, wherein the venue manager server system is configured to:
obtain event metadata describing one or more moments during the event; and
transmit the event metadata to a venue image server system.

14. The venue image capture system of claim 9, wherein:
the camera systems are configured to transmit the captured image data to the venue manager server system; and
the venue manager server system is configured to transmit the captured image data to a venue image server system.

15. The venue image capture system of claim 1, wherein a camera system in the set of camera systems is configured to transmit the captured image data to a venue image server system.

16. The venue image capture system of claim 1, further comprising a venue image server system wherein:
the venue image server system comprises a venue image server processor and a venue image server memory configured to store a venue image processing application; and
the venue image processing application configures the venue image server processor to:
obtain captured image data, where the captured image data corresponds to a sub-section of the venue;
obtain event metadata;
process the captured image data to generate processed image data, where the processed image data comprises metadata describing the location of the seat associated with the processed image data; and
associate a portion of the event metadata with the processed image data.

17. The venue image capture system of claim 16, wherein the venue image processing application further configures the venue image server processor to:
obtain advertisement targeting data, wherein the advertisement targeting data configures a fan experience device to display a piece of advertising data; and
associate advertisement targeting data with the processed image data.

18. The venue image capture of claim 16, wherein the venue image processing application further configures the venue image server processor to:
associate a set of advertising data with the processed image data based on the advertising targeting data; and
transmit the set of advertising data with the processed image data.

19. The venue image capture system of claim 1, wherein the fan experience application configures the processor to:
obtain advertising targeting data;
request advertising data; and
display the requested advertising data.

20. The venue image capture system of claim 19, wherein the advertising data is requested from a third-party advertising system.

21. The venue image capture system of claim 19, wherein the advertising data is requested from a venue image server system.

22. The venue image capture system of claim 19, wherein:
the fan experience application configures the processor to obtain user data describing the fan associated with the fan experience device; and
the advertising targeting data is based on the obtained user data.

23. The venue image capture system of claim 19, wherein:
the fan experience application configures the processor to:
measure engagement with the requested advertising data; and
generate engagement data describing the measured engagement; and
the engagement data is utilized to refine the advertising targeting data.

24. The venue image capture system of claim 23, wherein the generated engagement data further describes engagement with the fan engagement device.

25. The venue image capture system of claim 1, wherein the fan experience application configures the processor to:
obtain a token issued for a particular online social network that can be utilized to access a portion of the user's online social networking profile via an application programming interface provided by the online social network;
receive a request to share a processed image via the online social network; and
generate a post on the online social network using the token and the processed image.

26. The venue image capture system of claim 1, wherein the camera systems in the set of camera systems are configured to communicate in a peer-to-peer network.

27. A method for displaying image data captured during an event at a venue; comprising:
determining fan experience device location data using a fan experience device, where the fan experience device location data identifies a location within the venue associated with the fan;
obtaining processed image data using the fan experience device, wherein:
the processed image data is generated based on captured image data captured using a camera system installed in the venue and configured to capture the sub-section of the venue that includes the location described by the fan experience device location data, where:
the camera system comprises:
a camera comprising an imager configured to capture image data; and
a camera controller configured to:
obtain trigger data; and
configure the camera to capture an image; and
the camera system is configured to:
obtain a piece of trigger data;
capture a set of images in response to the trigger data, where the set of images captures a sub-section of the venue; and
transmit the set of images;
the processed image data comprises image data and metadata identifying the location captured in the processed image data; and
the location captured in the obtained processed image data corresponds to the determined fan experience device location data; and
displaying the obtained processed image data using the fan experience device.
